(19) United States
(12) Patent Application Publication
(10) Pub. No.: US 2026/0190207 A1
(43) Pub. Date: Jul. 2, 2026

(54) METHOD AND APPARATUS FOR OPERATING AND CONTROLLING COMBINED LAMP

(71) Applicant: APUTURE IMAGING INDUSTRIES CO., LTD., Shenzhen (CN)

(72) Inventors: Yaoting Kuang, Shenzhen (CN); Yanhao Xu, Shenzhen (CN)

(21) Appl. No.: 19/426,081

(22) Filed: Dec. 19, 2025

(30) Foreign Application Priority Data
Dec. 27, 2024 (CN) 202411982580.9

(51) Int. Cl. H05B 47/175; H05B 47/135; H05B 47/155; H05B 47/165

(52) U.S. Cl. CPC H05B 47/1985; H05B 47/135; H05B 47/155; H05B 47/165

(57) ABSTRACT

The present disclosure relates to the technical field of lighting control, and discloses a method and apparatus for operating and controlling a combined lamp. The method includes: receiving a lamp access signal of the combined lamp, and determining lamp access information of the combined lamp according to the lamp access signal; detecting a lamp splicing manner of the combined lamp according to the lamp quantity information; acquiring a scene lamp requirement of a usage scenario corresponding to the combined lamp, and generating lamp control parameters for the combined lamp according to the lamp splicing manner and the scene lamp requirement. Therefore, implementing the present disclosure may improve the convenience and efficiency of controlling lamps, improve the accuracy of multi-lamp control, improve the precision of light irradiation, and thereby enhance user experience.

### CROSS REFERENCE TO RELATED APPLICATIONS

The present disclosure claims the priority of Chinese Patent Application No. 2024119825809 filed on Dec. 27, 2024 before CNIPA. All the above are hereby incorporated by reference in their entirety.

### TECHNICAL FIELD

The present disclosure relates to the technical field of lighting control, and particularly to a method and apparatus for operating and controlling a combined lamp.

### BACKGROUND

Currently, with the rapid development of lighting technology, the usage scenarios of lamps are continuously increasing, and the combined use of multiple or various lamps is becoming more frequent. For example, in the field of film and television production, airbag lamp devices are widely used in on-set shooting due to their powerful lighting effects and flexibility, and multiple airbag lamps are often combined to achieve more ideal lighting effects.

However, due to the large volume of airbag lamp devices, when used in combination with multiple lighting modules, it requires operators to manually control each airbag lamp, and in order to form specific lighting patterns or effects that meet requirements, a large amount of debugging and operation on the installation sequence and position of the lighting modules is needed, the workload is heavy and the operation is cumbersome, resulting in low operational efficiency. Therefore, it is particularly important to propose a technical solution that may improve the convenience and efficiency of controlling lamps.

### SUMMARY

The present disclosure provides a method and apparatus for operating and controlling a combined lamp, which may facilitate improving the convenience and efficiency of controlling lamps.

To solve the above technical problem, disclosed in a first aspect of the present disclosure is a method for operating and controlling a combined lamp, the method includes:
receiving a lamp access signal of the combined lamp, and determining lamp access information of the combined lamp according to the lamp access signal, the lamp access information including lamp quantity information;
detecting a lamp splicing manner of the combined lamp according to the lamp quantity information, the lamp splicing manner including relative position parameters of sub-lamps in the combined lamp;
acquiring a scene lamp requirement of a usage scenario corresponding to the combined lamp, and generating lamp control parameters for the combined lamp according to the lamp splicing manner and the scene lamp requirement.

As an optional implementation, in the first aspect of the present disclosure, the detecting the lamp splicing manner of the combined lamp according to the lamp quantity information includes:
determining a lamp identifier of each sub-lamp when the lamp quantity information indicates that the combined lamp includes at least two sub-lamps;
detecting splicing information of lamp splicing points on each sub-lamp, the lamp splicing points being configured to splice the sub-lamp with other sub-lamps, each sub-lamp including at least one lamp splicing point;
determining relative position parameters of each sub-lamp according to splicing information of each lamp splicing point on each sub-lamp and the lamp identifier of each sub-lamp;
determining the lamp splicing manner of the combined lamp according to the relative position parameters of each sub-lamp.

As an optional implementation, in the first aspect of the present disclosure, the scene lamp requirement includes a scene light and shadow angle requirement and a scene light illumination color requirement, the lamp control parameters including a lamp response sequence control parameter and a color control parameter;
generating the lamp control parameters for the combined lamp according to the lamp splicing manner and the scene lamp requirement includes:
determining a lamp lighting logic corresponding to the combined lamp according to the lamp splicing manner and the scene light and shadow angle requirement, and generating the lamp response sequence control parameter for the combined lamp according to the lamp lighting logic;
generating the color control parameter for the combined lamp according to the scene light illumination color requirement.

As an optional implementation, in the first aspect of the present disclosure, the determining the lamp lighting logic corresponding to the combined lamp according to the lamp splicing manner and the scene light and shadow angle requirement includes:
filtering at least one lighting logic matching the lamp splicing manner from a preset lamp lighting logic database according to the lamp splicing manner;
determining a target lighting logic in each lighting logic according to the scene light and shadow angle requirement;
receiving a lighting logic adjustment instruction input by a user, and determining the lamp lighting logic corresponding to the combined lamp according to the lighting logic adjustment instruction and the target lighting logic.

As an optional implementation, in the first aspect of the present disclosure, each sub-lamp includes at least one lamp color block, the scene light illumination color requirement including a scene light distribution requirement and a light illumination color requirement;
generating the color control parameter for the combined lamp according to the scene light illumination color requirement includes:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region including a pure color block region and/or a gradient color block region;
determining a regional color control parameter for each color block region according to the light illumination color requirement, and generating the color control parameter for the combined lamp according to the regional color control parameter of each color block region.

As an optional implementation, in the first aspect of the present disclosure, the light illumination color requirement includes a light source requirement, a light effect requirement, and a color requirement;
determining the regional color control parameter for each color block region according to the light illumination color requirement includes:
determining a target light source for each color block region according to the light source requirement, the target light source including a tungsten filament light source, an incandescent light source, or a halogen light source;
determining light effect information and color information for each color block region according to the target light source of each color block region, the light effect requirement, and the color requirement, the light effect information including light effect type information and light effect change information, the color information including at least one of brightness information, color temperature information, and hue information;
determining the regional color control parameter for each color block region according to the target light source, the light effect information, and the color information of each color block region.

As an optional implementation, in the first aspect of the present disclosure, the scene lamp requirement includes a single lamp light distribution requirement and a single lamp color requirement when the lamp quantity information indicates that the combined lamp includes one sub-lamp;
generating the lamp control parameters for the combined lamp according to the lamp splicing manner and the scene lamp requirement includes:
filtering at least one target color block that needs to be lit in the sub-lamp according to the single lamp light distribution requirement;
determining a target color block position parameter of each target color block, and determining a color control parameter for each target lamp bead in each target color block according to the target color block position parameter of each target color block and the single lamp color requirement, each target color block including at least one target lamp bead;
generating the lamp control parameters for each sub-lamp according to the target color block position parameter of each target color block and the color control parameter for each target lamp bead in each target color block.

Disclosed in a second aspect of the present disclosure is an apparatus for operating and controlling a combined lamp, the apparatus includes a processor configured as:
a receiving module to receive a lamp access signal of the combined lamp, and determine lamp access information of the combined lamp according to the lamp access signal, the lamp access information including lamp quantity information;
a detection module to detect a lamp splicing manner of the combined lamp according to the lamp quantity information;
an acquisition module to acquire a scene lamp requirement of a usage scenario corresponding to the combined lamp, and generate lamp control parameters for the combined lamp according to the lamp splicing manner and the scene lamp requirement.

As an optional implementation, in the second aspect of the present disclosure, the steps of the detection module detecting the lamp splicing manner of the combined lamp according to the lamp quantity information specifically include:
determining a lamp identifier of each sub-lamp when the lamp quantity information indicates that the combined lamp includes at least two sub-lamps;
detecting splicing information of lamp splicing points on each sub-lamp, the lamp splicing points being configured to splice the sub-lamp with other sub-lamps, each sub-lamp including at least one lamp splicing point;
determining relative position parameters of each sub-lamp according to splicing information of each lamp splicing point on each sub-lamp and the lamp identifier of each sub-lamp;
determining the lamp splicing manner of the combined lamp according to the relative position parameters of each sub-lamp.

As an optional implementation, in the second aspect of the present disclosure, the scene lamp requirement includes a scene light and shadow angle requirement and a scene light illumination color requirement, the lamp control parameters including a lamp response sequence control parameter and a color control parameter;
the steps of the acquisition module generating the lamp control parameters for the combined lamp according to the lamp splicing manner and the scene lamp requirement specifically include:
determining a lamp lighting logic corresponding to the combined lamp according to the lamp splicing manner and the scene light and shadow angle requirement, and generating the lamp response sequence control parameter for the combined lamp according to the lamp lighting logic;
generating the color control parameter for the combined lamp according to the scene light illumination color requirement.

As an optional implementation, in the second aspect of the present disclosure, the steps of the acquisition module determining the lamp lighting logic corresponding to the combined lamp according to the lamp splicing manner and the scene light and shadow angle requirement specifically include:
filtering at least one lighting logic matching the lamp splicing manner from a preset lamp lighting logic database according to the lamp splicing manner;
determining a target lighting logic in each lighting logic according to the scene light and shadow angle requirement;
receiving a lighting logic adjustment instruction input by a user, and determining the lamp lighting logic corresponding to the combined lamp according to the lighting logic adjustment instruction and the target lighting logic.

As an optional implementation, in the second aspect of the present disclosure, each sub-lamp includes at least one lamp color block, the scene light illumination color requirement including a scene light distribution requirement and a light illumination color requirement;
the steps of the acquisition module generating the color control parameter for the combined module lamp according to the scene light illumination color requirement specifically include:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region including a pure color block region and/or a gradient color block region;
determining a regional color control parameter for each color block region according to the light illumination color requirement, and generating the color control parameter for the combined lamp according to the regional color control parameter of each color block region.

As an optional implementation, in the second aspect of the present disclosure, the light illumination color requirement includes a light source requirement, a light effect requirement, and a color requirement;
the steps of the acquisition module determining the regional color control parameter for each color block module region according to the light illumination color requirement specifically include:
determining a target light source for each color block region according to the light source requirement, the target light source including a tungsten filament light source, an incandescent light source, or a halogen light source;
determining light effect information and color information for each color block region according to the target light source of each color block region, the light effect requirement, and the color requirement, the light effect information including light effect type information and light effect change information, the color information including at least one of brightness information, color temperature information, and hue information;
determining the regional color control parameter for each color block region according to the target light source, the light effect information, and the color information of each color block region.

As an optional implementation, in the second aspect of the present disclosure, the scene lamp requirement includes a single lamp light distribution requirement and a single lamp color requirement when the lamp quantity information indicates that the combined lamp includes one sub-lamp;
the steps of the acquisition module generating the lamp control parameters for the combined lamp according to the lamp splicing manner and the scene lamp requirement specifically include:
filtering at least one target color block that needs to be lit in the sub-lamp according to the single lamp light distribution requirement;
determining a target color block position parameter of each target color block, and determining a color control parameter for each target lamp bead in each target color block according to the target color block position parameter of each target color block and the single lamp color requirement, each target color block including at least one target lamp bead;
generating the lamp control parameters for each sub-lamp according to the target color block position parameter of each target color block and the color control parameter for each target lamp bead in each target color block.

Disclosed in a third aspect of the present disclosure is another apparatus for operating and controlling a combined lamp, the apparatus including:
a memory, memorized with an executable code; and
a processor, coupled with the memory,
where the processor invokes the executable code memorized in the memory to perform the method for operating and controlling a combined lamp disclosed in the first aspect of the present disclosure.

Disclosed in a fourth aspect of the present disclosure is a non-transitory computer memory medium, and the non-transitory computer memory medium memorizes computer instructions; when the computer instructions are invoked, the method for operating and controlling a combined lamp disclosed in the first aspect of the present disclosure is performed.

Compared to the prior art, the embodiments of the present disclosure have beneficial effects as follows.

In embodiments of the present disclosure, receiving a lamp access signal of a combined lamp, and determining lamp access information of the combined lamp according to the lamp access signal, detecting a lamp splicing manner of the combined lamp according to the lamp quantity information, acquiring a scene lamp requirement of a usage scenario corresponding to the combined lamp, and generating lamp control parameters for the combined lamp according to the lamp splicing manner and the scene lamp requirement. Therefore, implementing the present disclosure may improve the convenience and efficiency of controlling lamps, improve the accuracy of multi-lamp control, improve the precision of light irradiation, and thereby enhance user experience.

### BRIEF DESCRIPTION OF THE DRAWINGS

In order to illustrate the technical solutions of the embodiments of the present disclosure more clearly, the following drawings are briefly described as required in the context of the embodiments. Obviously, the following drawings illustrate only some of the embodiments of the present disclosure. Other relevant drawings may be obtained on the basis of these drawings without any creative effort by those skilled in the art.

FIG. 1 is a schematic flowchart of a method for operating and controlling a combined lamp disclosed in an embodiment of the present disclosure;

FIG. 2 is a schematic flowchart of another method for operating and controlling a combined lamp disclosed in an embodiment of the present disclosure;

FIG. 3 is a schematic structural diagram of an apparatus for operating and controlling a combined lamp disclosed in an embodiment of the present disclosure;

FIG. 4 is a schematic structural diagram of another apparatus for operating and controlling a combined lamp disclosed in an embodiment of the present disclosure.

### DETAILED DESCRIPTION

For a better understanding of the solutions of the present disclosure by those skilled in the art, the technical solutions in the embodiments of the present disclosure are clearly and completely described and discussed below in conjunction with the attached drawings of the embodiments of the present disclosure. Obviously, the embodiments described herein are only some of the embodiments of the present disclosure but not all of them. Based on the embodiments in the present disclosure, all other embodiments acquired by those skilled in the art without inventive effort fall within the scope of protection of the present disclosure.

The terms “first”, “second”, and the like in the specification, the claims and the above-mentioned drawings of the present disclosure are used to identify different objects and are not intended to describe a particular sequence. In addition, the terms “include” and “include”, and any derivatives and conjugations thereof, are intended to cover non-exclusive inclusion. For example, a process, method, apparatus, product, or device that includes a series of steps or units is not limited to the listed steps or units, but optionally also includes steps or units that are not listed, or optionally also includes other steps or units that are inherent to those processes, methods, products, or devices.

The term “embodiment” herein means that a particular feature, structure or characteristic described in conjunction with an embodiment may be included in at least one embodiment of the present disclosure. The presence of the term in various places in the specification does not necessarily indicate the same embodiment, nor is it a separate or alternative embodiment that is mutually exclusive with other embodiments. It is understood, both explicitly and implicitly, by those skilled in the art that the embodiments described herein may be combined with other embodiments.

Disclosed are a method and apparatus for operating and controlling a combined lamp, which may improve the convenience and efficiency of controlling lamps, improve the accuracy of multi-lamp control, improve the precision of light irradiation, and thereby enhance user experience. The following will provide a detailed description respectively.

### Embodiment 1

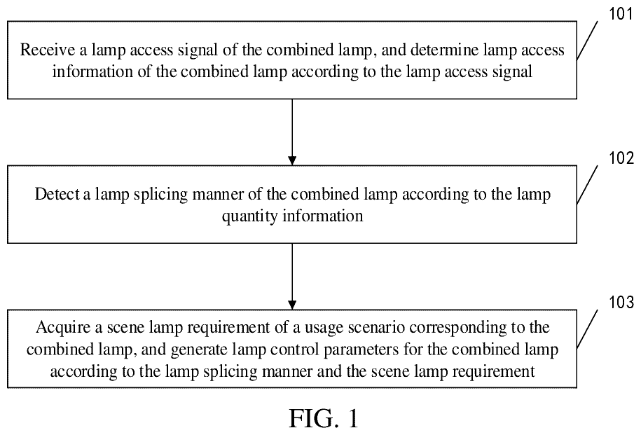

Referring to FIG. 1, FIG. 1 is a schematic flowchart of a method for operating and controlling a combined lamp disclosed in an embodiment of the present disclosure. The method for operating and controlling a combined lamp described in FIG. 1 may be applied to an apparatus for operating and controlling a combined lamp, where the apparatus for operating and controlling a combined lamp may include any one of user equipment, intelligent servers, or intelligent platforms for controlling the combined lamp, the user equipment including but not limited to at least one of smartphones (Android phones, iOS phones, etc.), tablet computers, etc., intelligent servers including local servers or cloud servers, which is not limited in the present embodiment of the disclosure. As shown in FIG. 1, the method for operating and controlling a combined lamp may include the following operations:
101, Receive a lamp access signal of the combined lamp, and determine lamp access information of the combined lamp according to the lamp access signal.

In an embodiment of the present disclosure, optionally, the combined lamp may include at least one sub-lamp, the lamp access signal of the combined lamp may include an access signal of each sub-lamp, the lamp access signal may include an electrical signal or a wireless signal, when a plug of the sub-lamp is accessed to a system, an access electrical signal transmitted by the plug of the sub-lamp may be received, a user may perform graphical parameter setting on the combined lamp through a display device based on a wired connection manner, to achieve control of the combined lamp, for example, the user may connect the combined lamp through a computer in a wired manner, and control the combined lamp on the computer, the user may also perform graphical parameter setting on the combined lamp through a display device based on a wireless connection manner, to achieve control of the combined lamp, for example, the user may wirelessly connect with the combined lamp through a mobile phone device, such as Bluetooth connection, and perform graphical parameter setting on the combined lamp through the mobile phone device, which is not limited in the present disclosure.

In an embodiment of the present disclosure, optionally, the lamp access information of the combined lamp may be determined according to the lamp access signal, the lamp access information may include lamp quantity information, that is, the quantity of sub-lamps in the combined lamp, which is not limited in the present disclosure.
102, Detect a lamp splicing manner of the combined lamp according to the lamp quantity information.

In an embodiment of the present disclosure, optionally, the lamp splicing manner of the combined lamp may be detected according to the lamp quantity information, specifically, relative position parameters of sub-lamps in the combined lamp may be determined according to the lamp quantity information, thereby determining the lamp splicing manner of the combined lamp, when the combined lamp includes only one sub-lamp, the lamp splicing manner includes relative position parameters of the sub-lamp, when the combined lamp includes at least two sub-lamps, the lamp splicing manner includes relative position parameters of each sub-lamp, and also includes a lamp splicing shape of the combined lamp, for example, square, triangle, trapezoid, straight line shape, etc., which is not limited in the present disclosure.
103, Acquire a scene lamp requirement of a usage scenario corresponding to the combined lamp, and generate lamp control parameters for the combined lamp according to the lamp splicing manner and the scene lamp requirement.

In an embodiment of the present disclosure, optionally, the usage scenario corresponding to the combined lamp may include at least one of public lighting scenario, outdoor lighting scenario, indoor lighting scenario, photographic lighting scenario, landscape lighting scenario, stage lighting scenario, etc., the scene lamp requirement may include a scene light and shadow angle requirement and a scene light illumination color requirement, which is not limited in the present disclosure.

In an embodiment of the present disclosure, optionally, the lamp control parameters for the combined lamp may include a lamp response sequence control parameter and a color control parameter, the lamp response sequence control parameter may be used to control a working response sequence of each sub-lamp in the combined lamp, the color control parameter may be used to control one or a combination of parameters such as color temperature, brightness, color, hue, light effect, etc. of the combined lamp, which is not limited in the present disclosure.

Therefore, implementing the method for operating and controlling a combined lamp described in FIG. 1 may receive a lamp access signal of the combined lamp, and determine lamp access information of the combined lamp according to the lamp access signal, detect a lamp splicing manner of the combined lamp according to the lamp quantity information, acquire a scene lamp requirement of a usage scenario corresponding to the combined lamp, and generate lamp control parameters for the combined lamp according to the lamp splicing manner and the scene lamp requirement, which may improve the convenience and efficiency of controlling lamps, improve the accuracy of multi-lamp control, improve the precision of light irradiation, and thereby enhance user experience.

In an optional implementation, the scene lamp requirement includes a scene light and shadow angle requirement and a scene light illumination color requirement, the lamp control parameters including a lamp response sequence control parameter and a color control parameter;
the generating the lamp control parameters for the combined lamp according to the lamp splicing manner and the scene lamp requirement may include the following steps:
determining a lamp lighting logic corresponding to the combined lamp according to the lamp splicing manner and the scene light and shadow angle requirement, and generating the lamp response sequence control parameter for the combined lamp according to the lamp lighting logic;
generating the color control parameter for the combined lamp according to the scene light illumination color requirement.

In this optional embodiment, optionally, the scene lamp requirement may include at least one of a scene light and shadow angle requirement and a scene light illumination color requirement, the lamp control parameters may include a lamp response sequence control parameter and a color control parameter, the scene light and shadow angle requirement may include at least one of a scene light and shadow angle, a scene light and shadow angle change, and a scene light and shadow angle duration, the lamp lighting logic corresponding to the combined lamp may be determined according to the lamp splicing manner and the scene light and shadow angle requirement, the lamp lighting logic satisfies the scene light and shadow angle requirement, the lamp response sequence control parameter may include a lighting sequence parameter of each sub-lamp in the combined lamp, and may also include a lighting sequence parameter of each lamp bead in each sub-lamp, which is not limited in the present embodiment.

In this optional embodiment, optionally, the scene light illumination color requirement may include at least one of a scene light illumination color parameter requirement and a scene light illumination color change requirement, the color control parameter for the combined lamp may be generated according to the scene light illumination color requirement, which is not limited in the present embodiment.

Therefore, implementing this optional embodiment may determine the lamp lighting logic corresponding to the combined lamp according to the lamp splicing manner and the scene light and shadow angle requirement, and generate the lamp response sequence control parameter for the combined lamp according to the lamp lighting logic, generate the color control parameter for the combined lamp according to the scene light illumination color requirement, may determine the lamp response sequence control parameter and the color control parameter for the combined lamp, improve the convenience and efficiency of controlling the combined lamp, improve the accuracy of multi-lamp control, improve the precision of light irradiation, and thereby enhance user experience.

In another optional implementation, the determining the lamp lighting logic corresponding to the combined lamp according to the lamp splicing manner and the scene light and shadow angle requirement may include the following steps:
filtering at least one lighting logic matching the lamp splicing manner from a preset lamp lighting logic database according to the lamp splicing manner;
determining a target lighting logic in each lighting logic according scene light and shadow angle requirement;
receiving logic adjustment instruction input by a user, and determining the lamp lighting logic corresponding to the combined lamp according to the lighting logic adjustment instruction and the target lighting logic.

In this optional embodiment, optionally, the preset lamp lighting logic database may include at least one lamp lighting logic corresponding to each lamp splicing manner, specifically, it may include at least one lamp lighting logic corresponding to each lamp splicing shape, such as square, rectangle, straight line shape, trapezoid, triangle, etc., at least one lighting logic matching the lamp splicing manner may be filtered from the preset lamp lighting logic database according to the lamp splicing manner, for example, when the lamp splicing manner indicates that the lamp splicing shape of the combined lamp is a triangle, each lighting logic corresponding to the triangle is filtered from the preset lamp lighting logic database, each lighting logic may achieve a light and shadow angle effect under such lamp splicing shape, which is not limited in the present embodiment.

In this optional embodiment, optionally, a target lighting logic may be determined in each lighting logic according to the scene light and shadow angle requirement, the target lighting logic may satisfy the scene light and shadow angle requirement, or, the light and shadow angle effect achieved by the target lighting logic has the highest matching degree with the scene light and shadow angle requirement, which is not limited in the present embodiment.

In this optional embodiment, optionally, after the target lighting logic is determined, the user may adjust the target lighting logic according to actual conditions or special requirements, that is, a lighting logic adjustment instruction input by the user may be received, and the lamp lighting logic corresponding to the combined lamp may be determined according to the lighting logic adjustment instruction and the target lighting logic, which is not limited in the present embodiment.

In this optional embodiment, optionally, when there is no lighting logic matching the lamp splicing manner in the preset lamp lighting logic database, a lighting logic for the lamp splicing manner may be generated according to the scene light and shadow angle requirement, and the generated lighting logic may be modified based on the lighting logic adjustment instruction input by the user to obtain the final lamp lighting logic, which is not limited in the present embodiment.

Therefore, implementing this optional embodiment may filter at least one lighting logic matching the lamp splicing manner from the preset lamp lighting logic database according to the lamp splicing manner, determine the target lighting logic in each lighting logic according to the scene light and shadow angle requirement, receive the lighting logic adjustment instruction input by the user, and determine the lamp lighting logic corresponding to the combined lamp according to the lighting logic adjustment instruction and the target lighting logic, which may improve the accuracy and reliability of the determined lamp lighting logic, thereby improving the control efficiency and accuracy of the combined lamp.

In yet another optional implementation, each sub-lamp includes at least one lamp color block, the scene light illumination color requirement including a scene light distribution requirement and a light illumination color requirement;
the generating the color control parameter for the combined lamp according to the scene light illumination color requirement may include the following steps:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region including a pure color block region and/or a gradient color block region;
determining a regional color control parameter for each color block region according to the light illumination color requirement, and generating the color control parameter for the combined lamp according to the regional color control parameter of each color block region.

In this optional embodiment, optionally, the scene light illumination color requirement may include a scene light distribution requirement and a light illumination color requirement, the color block position parameter of each lamp color block in each sub-lamp may be determined according to the relative position parameters of each sub-lamp, each sub-lamp may include at least one lamp color block, and the color parameter of each lamp color block may be individually controlled, which is not limited in the present embodiment.

In this optional embodiment, optionally, at least one color block region of each sub-lamp may be determined according to the scene light distribution requirement and the color block position parameter of each lamp color block, the color block region may represent an area that needs to be lit and operated, that is, all color blocks or partial color blocks may be lit in one sub-lamp, each color block region may include a pure color block region and/or a gradient color block region, that is, colors of different color block regions in one sub-lamp may be different, which is not limited in the present embodiment.

In this optional embodiment, optionally, a regional color control parameter for each color block region may be determined according to the light illumination color requirement, the regional color control parameter may include at least one of a light source control parameter, a light effect control parameter, and a color control parameter, the color control parameter for the combined lamp may be generated according to the regional color control parameter of each color block region, which is not limited in the present embodiment.

Therefore, implementing this optional embodiment may determine the color block position parameter of each lamp color block in each sub-lamp according to the relative position parameters of each sub-lamp, determine at least one color block region of each sub-lamp according to the scene light distribution requirement and the color block position parameter of each lamp color block, determine the regional color control parameter for each color block region according to the light illumination color requirement, and generate the color control parameter for the combined lamp according to the regional color control parameter of each color block region, which may determine the regional color control parameter of each color block region in the sub-lamp, thereby determining the color control parameter of the combined lamp, improve the color control accuracy of the combined lamp, improve the diversification degree of color control of the combined lamp, thereby improving the precision of light irradiation, and thereby enhance user experience.

In yet another optional implementations, the light illumination color requirement includes a light source requirement, a light effect requirement, and a color requirement;
the determining the regional color control parameter for each color block region according to the light illumination color requirement may include the following steps:
determining a target light source for each color block region according to the light source requirement, the target light source including a tungsten filament light source, an incandescent light source, or a halogen light source;
determining light effect information and color information for each color block region according to the target light source of each color block region, the light effect requirement, and the color requirement, the light effect information including light effect type information and light effect change information, the color information including at least one of brightness information, color temperature information, and hue information;
determining the regional color control parameter for each color block region according to the target light source, the light effect information, and the color information of each color block region.

In this optional embodiment, optionally, the light illumination color requirement may include a light source requirement, a light effect requirement, and a color requirement, a target light source for each color block region may be determined according to the light source requirement, the target light source may include a tungsten filament light source, an incandescent light source, or a halogen light source, light effect information and color information for each color block region may be determined according to the target light source of each color block region, the light effect requirement, and the color requirement, the light effect information may include light effect type information and light effect change information, the color information may include at least one of brightness information, color temperature information, and hue information, where the light effect type information may include one of fire line light effect, paparazzi light effect, and faulty bulb light effect, the light effect change information may include one or a combination of light effect brightness, light effect color temperature, light effect operating speed, light effect change speed, light effect stop time, etc., which is not limited in the present embodiment.

Therefore, implementing this optional embodiment may determine the target light source for each color block region according to the light source requirement, determine the light effect information and color information for each color block region according to the target light source of each color block region, the light effect requirement, and the color requirement, determine the regional color control parameter for each color block region according to the target light source, the light effect information, and the color information of each color block region, which may achieve precise control of the light source, light effect, and color of the combined lamp, improve the control accuracy of the combined lamp, improve the diversification degree of control of the combined lamp, thereby improving the precision of light irradiation, and thereby enhance user experience.

### Embodiment 2

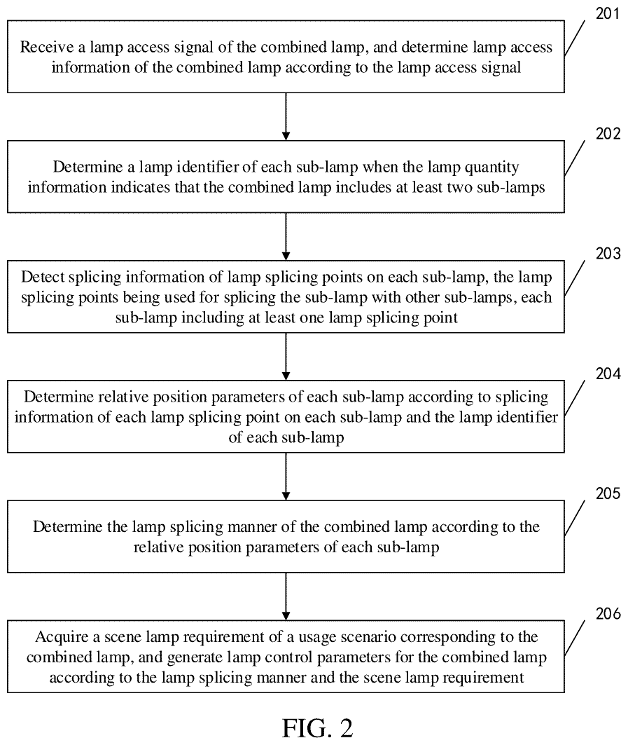

Referring to FIG. 2, FIG. 2 is a schematic flowchart of a method for operating and controlling a combined lamp disclosed in an embodiment of the present disclosure. The method for operating and controlling a combined lamp described in FIG. 2 may be applied to an apparatus for operating and controlling a combined lamp, where the apparatus for operating and controlling a combined lamp may include any one of user equipment, intelligent servers, or intelligent platforms for controlling the combined lamp, the user equipment including but not limited to at least one of smartphones (Android phones, iOS phones, etc.), tablet computers, etc., intelligent servers including local servers or cloud servers, which is not limited in the present embodiment of the disclosure. As shown in FIG. 2, the method for operating and controlling a combined lamp may include the following operations:
201, Receive a lamp access signal of the combined lamp, and determine lamp access information of the combined lamp according to the lamp access signal.
202, Determine a lamp identifier of each sub-lamp when the lamp quantity information indicates that the combined lamp includes at least two sub-lamps.

In an embodiment of the present disclosure, optionally, the lamp identifier may represent a unique identification identifier of the sub-lamp, when the lamp quantity information indicates that the combined lamp includes at least two sub-lamps, the sub-lamp may be identified and related information of the sub-lamp may be obtained through the lamp identifier of each sub-lamp, for example, at least one of the type of the sub-lamp, lighting parameters, the number of lamp beads, etc., which is not limited in the present embodiment.
203, Detect splicing information of lamp splicing points on each sub-lamp, the lamp splicing points being used for splicing the sub-lamp with other sub-lamps, each sub-lamp including at least one lamp splicing point.

In an embodiment of the present disclosure, optionally, the lamp splicing points may be used for splicing the sub-lamp with other sub-lamps, the splicing manner between sub-lamps may include at least one of bolt splicing manner, plug-in manner, buckle splicing manner, lock splicing manner, and adhesive manner, the lamp splicing points may transmit electrical signals, when sub-lamp A is spliced with sub-lamp B, lamp splicing point A on sub-lamp A is connected with lamp splicing point B on sub-lamp B, when the combined lamp is powered on, lamp splicing point A and lamp splicing point B are also electrically connected, thereby electrical signals may be transmitted through lamp splicing points A and B, each sub-lamp may include at least one lamp splicing point, the splicing information may include connection information of each lamp splicing point on the sub-lamp.
204, Determine relative position parameters of each sub-lamp according to splicing information of each lamp splicing point on each sub-lamp and the lamp identifier of each sub-lamp.

In an embodiment of the present disclosure, optionally, the relative position parameters of each sub-lamp may be determined according to splicing information of each lamp splicing point on each sub-lamp and the lamp identifier of each sub-lamp, specifically, a certain sub-lamp in the combined lamp may be taken as a reference lamp, the relative position parameters of each sub-lamp relative to the reference lamp may be determined according to splicing information of each lamp splicing point on each sub-lamp and the lamp identifier of each sub-lamp, the relative position parameters may include coordinate parameters, which is not limited in the present disclosure.
205, Determine the lamp splicing manner of the combined lamp according to the relative position parameters of each sub-lamp.

In an embodiment of the present disclosure, optionally, the overall shape parameters of the combined lamp formed by splicing each sub-lamp may be determined according to the relative position parameters of each sub-lamp, thereby obtaining the lamp splicing manner of the combined lamp, the lamp splicing manner of the combined lamp may include relative position parameters of each sub-lamp in the combined lamp and overall shape parameters of the combined lamp, which is not limited in the present disclosure.
206, Acquire a scene lamp requirement of a usage scenario corresponding to the combined lamp, and generate lamp control parameters for the combined lamp according to the lamp splicing manner and the scene lamp requirement.

In an embodiment of the present disclosure, for other descriptions of step 201 and step 206, please refer to the detailed descriptions of step 101 and step 103 in Embodiment 1 of the present disclosure, which will not be repeated in the present embodiment of the disclosure.

Therefore, implementing the method for operating and controlling a combined lamp described in FIG. 2 may receive a lamp access signal of the combined lamp, and determine lamp access information of the combined lamp according to the lamp access signal, when the lamp quantity information indicates that the combined lamp includes at least two sub-lamps, determine a lamp identifier of each sub-lamp, detect splicing information of lamp splicing points on each sub-lamp, the lamp splicing points being used for splicing the sub-lamp with other sub-lamps, each sub-lamp including at least one lamp splicing point, determine relative position parameters of each sub-lamp according to splicing information of each lamp splicing point on each sub-lamp and the lamp identifier of each sub-lamp, determine the lamp splicing manner of the combined lamp according to the relative position parameters of each sub-lamp, improve the accuracy of determining the lamp splicing manner of the combined lamp, thereby improving the control accuracy and convenience of the combined lamp, acquire a scene lamp requirement of a usage scenario corresponding to the combined lamp, and generate lamp control parameters for the combined lamp according to the lamp splicing manner and the scene lamp requirement, which may improve the convenience and efficiency of controlling lamps, improve the accuracy of multi-lamp control, improve the precision of light irradiation, and thereby enhance user experience.

In an optional implementation, the scene lamp requirement includes a single lamp light distribution requirement and a single lamp color requirement when the lamp quantity information indicates that the combined lamp includes one sub-lamp;
the generating the lamp control parameters for the combined lamp according to the lamp splicing manner and the scene lamp requirement may include the following steps:
filtering at least one target color block that needs to be lit in the sub-lamp according to the single lamp light distribution requirement;
determining a target color block position parameter of each target color block, and determining a color control parameter for each target lamp bead in each target color block according to the target color block position parameter of each target color block and the single lamp color requirement, each target color block including at least one target lamp bead;
generating the lamp control parameters for each sub-lamp according to the target color block position parameter of each target color block and the color control parameter for each target lamp bead in each target color block.

In this optional embodiment, optionally, the sub-lamp may be divided into multiple color block regions, the size of each color block region may be the same or different, when the lamp quantity information indicates that the combined lamp includes one sub-lamp, the scene lamp requirement may include a single lamp light distribution requirement and a single lamp color requirement, at least one target color block that needs to be lit may be filtered in the sub-lamp according to the single lamp light distribution requirement, that is, all color block regions in the sub-lamp may be lit, or only partial color block regions in the sub-lamp may be lit, which is not limited in the present embodiment.

In this optional embodiment, optionally, a target color block position parameter of each target color block may be determined, and then a color control parameter for each target lamp bead in each target color block may be determined according to the target color block position parameter of each target color block and the single lamp color requirement, each target color block includes at least one target lamp bead, that is, working colors of target lamp beads in the same target color block may be the same or different, the lamp control parameters for each sub-lamp may be generated according to the target color block position parameter of each target color block and the color control parameter for each target lamp bead in each target color block, which is not limited in the present embodiment.

Therefore, implementing this optional embodiment may filter at least one target color block that needs to be lit in the sub-lamp according to the single lamp light distribution requirement, determine the target color block position parameter of each target color block, and determine the color control parameter for each target lamp bead in each target color block according to the target color block position parameter of each target color block and the single lamp color requirement, generate the lamp control parameters for each sub-lamp according to the target color block position parameter of each target color block and the color control parameter for each target lamp bead in each target color block, which may achieve precise control of color blocks and lamps in the sub-lamp when the combined lamp includes one sub-lamp, improve the control efficiency and accuracy of the combined lamp, thereby improving the precision of light irradiation, and thereby enhance user experience.

### Embodiment 3

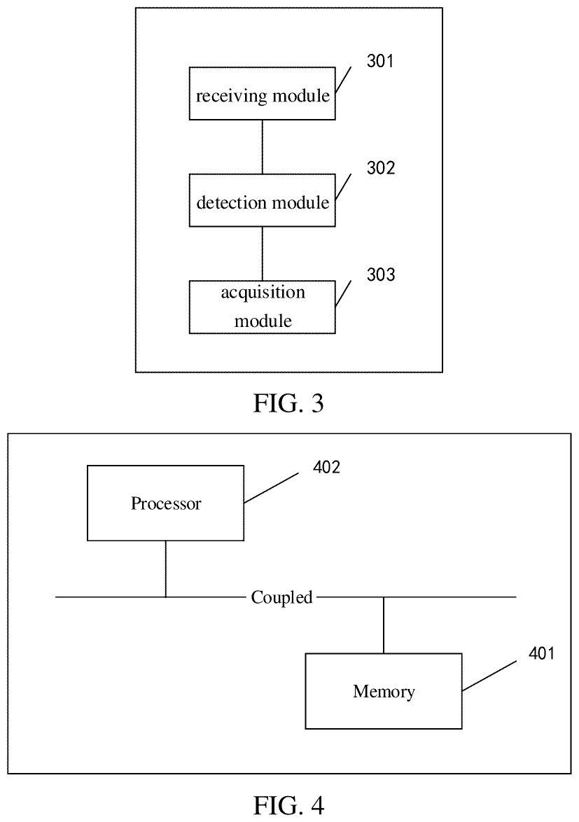

Referring to FIG. 3, FIG. 3 is a schematic structural diagram of an apparatus for operating and controlling a combined lamp disclosed in an embodiment of the present disclosure. The apparatus for operating and controlling a combined lamp described in FIG. 3 may include any one of user equipment, intelligent servers, or intelligent platforms for controlling the combined lamp, the user equipment including but not limited to at least one of smartphones (Android phones, iOS phones, etc.), tablet computers, etc., intelligent servers including local servers or cloud servers, which is not limited in the present embodiment of the disclosure. As shown in FIG. 3, the apparatus for operating and controlling a combined lamp may include a processor configured as:
a receiving module 301 to receive a lamp access signal of the combined lamp, and determine lamp access information of the combined lamp according to the lamp access signal, the lamp access information including lamp quantity information;
a detection module 302 to detect a lamp splicing manner of the combined lamp according to quantity information;
an acquisition module 303 to acquire a scene lamp requirement usage scenario corresponding to the combined lamp, and generate lamp control parameters for the combined lamp according to the lamp splicing manner and the scene lamp requirement.

Therefore, implementing the apparatus for operating and controlling a combined lamp described in FIG. 3 may receive a lamp access signal of the combined lamp, and determine lamp access information of the combined lamp according to the lamp access signal, detect a lamp splicing manner of the combined lamp according to the lamp quantity information, acquire a scene lamp requirement of a usage scenario corresponding to the combined lamp, and generate lamp control parameters for the combined lamp according to the lamp splicing manner and the scene lamp requirement, which may improve the convenience and efficiency of controlling lamps, improve the accuracy of multi-lamp control, improve the precision of light irradiation, and thereby enhance user experience.

In an optional implementation, as shown in FIG. 3, the steps of the detection module 302 detecting a lamp splicing manner of the combined lamp according to the lamp quantity information specifically include;
determining a lamp identifier of each sub-lamp when the lamp quantity information indicates that the combined lamp includes at least two sub-lamps;
detecting splicing information of lamp splicing points on each sub-lamp, the lamp splicing points being configured to splice the sub-lamp with other sub-lamps, each sub-lamp including at least one lamp splicing point;
determining relative position parameters of each sub-lamp according to splicing information of each lamp splicing point on each sub-lamp and the lamp identifier of each sub-lamp;
determining the lamp splicing manner of the combined lamp according to the relative position parameters of each sub-lamp.

Therefore, implementing the apparatus for operating and controlling a combined lamp described in FIG. 3 may receive a lamp access signal of the combined lamp, and determine lamp access information of the combined lamp according to the lamp access signal, when the lamp quantity information indicates that the combined lamp includes at least two sub-lamps, determine a lamp identifier of each sub-lamp, detect splicing information of lamp splicing points on each sub-lamp, the lamp splicing points being used for splicing the sub-lamp with other sub-lamps, each sub-lamp including at least one lamp splicing point, determine relative position parameters of each sub-lamp according to splicing information of each lamp splicing point on each sub-lamp and the lamp identifier of each sub-lamp, determine the lamp splicing manner of the combined lamp according to the relative position parameters of each sub-lamp, improve the accuracy of determining the lamp splicing manner of the combined lamp, thereby improving the control accuracy and convenience of the combined lamp, acquire a scene lamp requirement of a usage scenario corresponding to the combined lamp, and generate lamp control parameters for the combined lamp according to the lamp splicing manner and the scene lamp requirement, which may improve the convenience and efficiency of controlling lamps, improve the accuracy of multi-lamp control, improve the precision of light irradiation, and thereby enhance user experience.

In another optional implementations, as shown in FIG. 3, the scene lamp requirement includes a scene light and shadow angle requirement and a scene light illumination color requirement, the lamp control parameters including a lamp response sequence control parameter and a color control parameter;
the steps of the acquisition module 303 generating the lamp control parameters for the combined lamp according to the lamp splicing manner and the scene lamp requirement specifically include:
determining a lamp lighting logic corresponding to the combined lamp according to the lamp splicing manner and the scene light and shadow angle requirement, and generating the lamp response sequence control parameter for the combined lamp according to the lamp lighting logic;
generating the color control parameter for the combined lamp according to the scene light illumination color requirement.

Therefore, implementing the apparatus for operating and controlling a combined lamp described in FIG. 3 may determine the lamp lighting logic corresponding to the combined lamp according to the lamp splicing manner and the scene light and shadow angle requirement, and generate the lamp response sequence control parameter for the combined lamp according to the lamp lighting logic, generate the color control parameter for the combined lamp according to the scene light illumination color requirement, may determine the lamp response sequence control parameter and the color control parameter for the combined lamp, improve the convenience and efficiency of controlling the combined lamp, improve the accuracy of multi-lamp control, improve the precision of light irradiation, and thereby enhance user experience.

In yet another implementation, as shown in FIG. 3, the steps of the acquisition module 303 determining the lamp lighting logic corresponding to the combined lamp according to the lamp splicing manner and the scene light and shadow angle requirement specifically include:
filtering at least one lighting logic matching the lamp splicing manner from a preset lamp lighting logic database according to the lamp splicing manner;
determining a target lighting logic in each lighting logic according scene light and shadow angle requirement;
receiving logic adjustment instruction input by a user, and determining the lamp lighting logic corresponding to the combined lamp according to the lighting logic adjustment instruction and the target lighting logic.

Therefore, implementing the apparatus for operating and controlling a combined lamp described in FIG. 3 may filter at least one lighting logic matching the lamp splicing manner from the preset lamp lighting logic database according to the lamp splicing manner, determine the target lighting logic in each lighting logic according to the scene light and shadow angle requirement, receive the lighting logic adjustment instruction input by the user, and determine the lamp lighting logic corresponding to the combined lamp according to the lighting logic adjustment instruction and the target lighting logic, which may improve the accuracy and reliability of the determined lamp lighting logic, thereby improving the control efficiency and accuracy of the combined lamp.

In yet another optional implementation, as shown in FIG. 3, each sub-lamp includes at least one lamp color block, the scene light illumination color requirement including a scene light distribution requirement and a light illumination color requirement;
the steps of the acquisition module 303 generating the color control parameter for the combined lamp according to the scene light illumination color requirement specifically include:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region including a pure color block region and/or a gradient color block region;
determining a regional color control parameter for each color block region according to the light illumination color requirement, and generating the color control parameter for the combined lamp according to the regional color control parameter of each color block region.

Therefore, implementing the apparatus for operating and controlling a combined lamp described in FIG. 3 may determine the color block position parameter of each lamp color block in each sub-lamp according to the relative position parameters of each sub-lamp, determine at least one color block region of each sub-lamp according to the scene light distribution requirement and the color block position parameter of each lamp color block, determine the regional color control parameter for each color block region according to the light illumination color requirement, and generate the color control parameter for the combined lamp according to the regional color control parameter of each color block region, which may determine the regional color control parameter of each color block region in the sub-lamp, thereby determining the color control parameter of the combined lamp, improve the color control accuracy of the combined lamp, improve the diversification degree of color control of the combined lamp, thereby improving the precision of light irradiation, and thereby enhance user experience.

In yet another optional implementation, the light illumination color requirement includes a light source requirement, a light effect requirement, and a color requirement;
the steps of the acquisition module 303 determining the regional color control parameter for each color block region according to the light illumination color requirement specifically include:
determining a target light source for each color block region according to the light source requirement, the target light source including a tungsten filament light source, an incandescent light source, or a halogen light source;
determining light effect information and color information for each color block region according to the target light source of each color block region, the light effect requirement, and the color requirement, the light effect information including light effect type information and light effect change information, the color information including at least one of brightness information, color temperature information, and hue information;
determining the regional color control parameter for each color block region according to the target light source, the light effect information, and the color information of each color block region.

Therefore, implementing the apparatus for operating and controlling a combined lamp described in FIG. 3 may determine the target light source for each color block region according to the light source requirement, determine the light effect information and color information for each color block region according to the target light source of each color block region, the light effect requirement, and the color requirement, determine the regional color control parameter for each color block region according to the target light source, the light effect information, and the color information of each color block region, which may achieve precise control of the light source, light effect, and color of the combined lamp, improve the control accuracy of the combined lamp, improve the diversification degree of control of the combined lamp, thereby improving the precision of light irradiation, and thereby enhance user experience.

In yet another optional implementation, the scene lamp requirement includes a single lamp light distribution requirement and a single lamp color requirement when the lamp quantity information indicates that the combined lamp includes one sub-lamp;
the steps of the acquisition module 303 generating the lamp control parameters for the combined lamp according to the lamp splicing manner and the scene lamp requirement specifically include:
filtering at least one target color block that needs to be lit in the sub-lamp according to the single lamp light distribution requirement;
determining a target color block position parameter of each target color block, and determining a color control parameter for each target lamp bead in each target color block according to the target color block position parameter of each target color block and the single lamp color requirement, each target color block including at least one target lamp bead;
generating the lamp control parameters for each sub-lamp according to the target color block position parameter of each target color block and the color control parameter for each target lamp bead in each target color block.

Therefore, implementing the apparatus for operating and controlling a combined lamp described in FIG. 3 may filter at least one target color block that needs to be lit in the sub-lamp according to the single lamp light distribution requirement, determine the target color block position parameter of each target color block, and determine the color control parameter for each target lamp bead in each target color block according to the target color block position parameter of each target color block and the single lamp color requirement, generate the lamp control parameters for each sub-lamp according to the target color block position parameter of each target color block and the color control parameter for each target lamp bead in each target color block, which may achieve precise control of color blocks and lamps in the sub-lamp when the combined lamp includes one sub-lamp, improve the control efficiency and accuracy of the combined lamp, thereby improving the precision of light irradiation, and thereby enhance user experience.

### Embodiment 4

Referring to FIG. 4, FIG. 4 is a schematic structural diagram of another apparatus for operating and controlling a combined lamp disclosed in an embodiment of the present disclosure. As shown in FIG. 4, the apparatus for operating and controlling a combined lamp may include:
a memory 401, memorized with an executable code; and
a processor 402, coupled with the memory 401,
where the processor 402 invokes the executable code memorized in the memory 401 to perform steps of the method for operating and controlling a combined lamp as described in the first embodiment or second embodiment.

### Embodiment 5

Disclosed in the present embodiment of the disclosure is a non-transitory computer memory medium, the non-transitory computer memory medium memorizes computer instructions; when the computer instructions are invoked, steps of the method for operating and controlling a combined lamp described in the first embodiment and second embodiment of the present disclosure are performed.

### Embodiment 6

Disclosed in the present embodiment of the disclosure is a computer program product, the computer program product including a non-transitory computer readable memory medium memorized with a computer program. The computer program may be operated to enable the computer to perform steps in the method for operating and controlling a combined lamp described in the first embodiment or second embodiment.

The aforementioned described embodiment of the apparatus is only illustrative. The modules described as separate components may or may not be physically separated, and the modules used as components for display may or may not be physical modules, that is, they may be located in the same place or may be distributed to a plurality of network modules. Some or all these modules may be selected according to practical demands to achieve the purpose of the solution of the present embodiment. It may be understood and performed by a person of ordinary skill in the art without inventive effort.

With the specific description of the above embodiments, it is clear to those skilled in the art that the various implementations may be implemented with the aid of software plus the necessary common hardware platform, and admittedly, with the aid of hardware. Based on such an understanding, the above technical solutions that essentially or contribute to the prior art may be embodied in the form of a software product which may be memorized in a non-transitory computer-readable memory medium, the non-transitory memory medium including Read-Only Memory, Random Access Memory, Programmable Read-only Memory, Erasable Programmable Read Only Memory, One-time Programmable Read-Only Memory, Electrically-Erasable Programmable Read-Only Memory, Compact Disc Read-Only Memory, other Compact Disc Memory, Disk Memory, Tape Memory or any other non-transitory computer-readable medium that may be used to carry or memorize data.

Finally, it should be noted that the method and apparatus for operating and controlling a combined lamp disclosed in the embodiments of the present disclosure are only preferred embodiments of the present disclosure, and are only used to illustrate the technical solutions of the present disclosure, but not to limit them. Despite the detailed description of the disclosure with reference to the aforementioned embodiments, it should be understood, by those skilled in the art, that the technical solutions recorded in the aforementioned embodiments may still be modified, or equivalent substitutions for some of the technical features thereof may be made; which the essence of the corresponding technical solutions of these modifications or substitutions is without departing from the spirit and scope of the technical solutions of the various embodiments of the disclosure.

What is claimed is:

1. A method for operating and controlling a combined lamp, wherein the method comprises:
receiving a lamp access signal of the combined lamp, and determining lamp access information of the combined lamp according to the lamp access signal, the lamp access information comprising lamp quantity information;
detecting a lamp splicing manner of the combined lamp according to the lamp quantity information, the lamp splicing manner comprising relative position parameters of sub-lamps in the combined lamp; and
acquiring a scene lamp requirement of a usage scenario corresponding to the combined lamp, and generating lamp control parameters for the combined lamp according to the lamp splicing manner and the scene lamp requirement.

2. The method for operating and controlling a combined lamp according to claim 1, wherein the detecting the lamp splicing manner of the combined lamp according to the lamp quantity information comprises:
determining a lamp identifier of each sub-lamp when the lamp quantity information indicates that the combined lamp comprises at least two sub-lamps;
detecting splicing information of lamp splicing points on each sub-lamp, the lamp splicing points being configured to splice the sub-lamp with other sub-lamps, each sub-lamp comprising at least one lamp splicing point;
determining relative position parameters of each sub-lamp according to splicing information of each lamp splicing point on each sub-lamp and the lamp identifier of each sub-lamp; and
determining the lamp splicing manner of the combined lamp according to the relative position parameters of each sub-lamp.

3. The method for operating and controlling a combined lamp according to claim 1, wherein the scene lamp requirement comprises a scene light and shadow angle requirement and a scene light illumination color requirement, the lamp control parameters comprising a lamp response sequence control parameter and a color control parameter;
generating the lamp control parameters for the combined lamp according to the lamp splicing manner and the scene lamp requirement comprises:
determining a lamp lighting logic corresponding to the combined lamp according to the lamp splicing manner and the scene light and shadow angle requirement, and generating the lamp response sequence control parameter for the combined lamp according to the lamp lighting logic; and
generating the color control parameter for the combined lamp according to the scene light illumination color requirement.

4. The method for operating and controlling a combined lamp according to claim 2, wherein the scene lamp requirement comprises a scene light and shadow angle requirement and a scene light illumination color requirement, the lamp control parameters comprising a lamp response sequence control parameter and a color control parameter;
generating the lamp control parameters for the combined lamp according to the lamp splicing manner and the scene lamp requirement comprises:
determining a lamp lighting logic corresponding to the combined lamp according to the lamp splicing manner and the scene light and shadow angle requirement, and generating the lamp response sequence control parameter for the combined lamp according to the lamp lighting logic; and
generating the color control parameter for the combined lamp according to the scene light illumination color requirement.

5. The method for operating and controlling a combined lamp according to claim 3, wherein the determining the lamp lighting logic corresponding to the combined lamp according to the lamp splicing manner and the scene light and shadow angle requirement comprises:
filtering at least one lighting logic matching the lamp splicing manner from a preset lamp lighting logic database according to the lamp splicing manner;
determining a target lighting logic in each lighting logic according to the scene light and shadow angle requirement; and
receiving a lighting logic adjustment instruction input by a user, and determining the lamp lighting logic corresponding to the combined lamp according to the lighting logic adjustment instruction and the target lighting logic.

6. The method for operating and controlling a combined lamp according to claim 4, wherein the determining the lamp lighting logic corresponding to the combined lamp according to the lamp splicing manner and the scene light and shadow angle requirement comprises:
filtering at least one lighting logic matching the lamp splicing manner from a preset lamp lighting logic database according to the lamp splicing manner;
determining a target lighting logic in each lighting logic according to the scene light and shadow angle requirement; and
receiving a lighting logic adjustment instruction input by a user, and determining the lamp lighting logic corresponding to the combined lamp according to the lighting logic adjustment instruction and the target lighting logic.

7. The method for operating and controlling a combined lamp according to claim 3, wherein each sub-lamp comprises at least one lamp color block, the scene light illumination color requirement comprising a scene light distribution requirement and a light illumination color requirement;
generating the color control parameter for the combined lamp according to the scene light illumination color requirement comprises:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region comprising a pure color block region and/or a gradient color block region; and
determining a regional color control parameter for each color block region according to the light illumination color requirement, and generating the color control parameter for the combined lamp according to the regional color control parameter of each color block region.

8. The method for operating and controlling a combined lamp according to claim 4, wherein each sub-lamp comprises at least one lamp color block, the scene light illumination color requirement comprising a scene light distribution requirement and a light illumination color requirement;
generating the color control parameter for the combined lamp according to the scene light illumination color requirement comprises:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region comprising a pure color block region and/or a gradient color block region; and
determining a regional color control parameter for each color block region according to the light illumination color requirement, and generating the color control parameter for the combined lamp according to the regional color control parameter of each color block region.

9. The method for operating and controlling a combined lamp according to claim 5, wherein each sub-lamp comprises at least one lamp color block, the scene light illumination color requirement comprising a scene light distribution requirement and a light illumination color requirement;
generating the color control parameter for the combined lamp according to the scene light illumination color requirement comprises:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region comprising a pure color block region and/or a gradient color block region; and
determining a regional color control parameter for each color block region according to the light illumination color requirement, and generating the color control parameter for the combined lamp according to the regional color control parameter of each color block region.

10. The method for operating and controlling a combined lamp according to claim 6, wherein each sub-lamp comprises at least one lamp color block, the scene light illumination color requirement comprising a scene light distribution requirement and a light illumination color requirement;
generating the color control parameter for the combined lamp according to the scene light illumination color requirement comprises:
determining a color block position parameter of each lamp color block in each sub-lamp according to the relative position parameters of each sub-lamp;
determining at least one color block region of each sub-lamp according to the scene light distribution requirement and the color block position parameter of each lamp color block, each color block region comprising a pure color block region and/or a gradient color block region; and
determining a regional color control parameter for each color block region according to the light illumination color requirement, and generating the color control parameter for the combined lamp according to the regional color control parameter of each color block region.

11. The method for operating and controlling a combined lamp according to claim 7, wherein the light illumination color requirement comprises a light source requirement, a light effect requirement, and a color requirement;
determining the regional color control parameter for each color block region according to the light illumination color requirement comprises:
determining a target light source for each color block region according to the light source requirement, the target light source comprising a tungsten filament light source, an incandescent light source, or a halogen light source;
determining light effect information and color information for each color block region according to the target light source of each color block region, the light effect requirement, and the color requirement, the light effect information comprising light effect type information and light effect change information, the color information comprising at least one of brightness information, color temperature information, and hue information; and
determining the regional color control parameter for each color block region according to the target light source, the light effect information, and the color information of each color block region.

12. The method for operating and controlling a combined lamp according to claim 8, wherein the light illumination color requirement comprises a light source requirement, a light effect requirement, and a color requirement;
determining the regional color control parameter for each color block region according to the light illumination color requirement comprises:
determining a target light source for each color block region according to the light source requirement, the target light source comprising a tungsten filament light source, an incandescent light source, or a halogen light source;
determining light effect information and color information for each color block region according to the target light source of each color block region, the light effect requirement, and the color requirement, the light effect information comprising light effect type information and light effect change information, the color information comprising at least one of brightness information, color temperature information, and hue information; and
determining the regional color control parameter for each color block region according to the target light source, the light effect information, and the color information of each color block region.

13. The method for operating and controlling a combined lamp according to claim 9, wherein the light illumination color requirement comprises a light source requirement, a light effect requirement, and a color requirement;
determining the regional color control parameter for each color block region according to the light illumination color requirement comprises:
determining a target light source for each color block region according to the light source requirement, the target light source comprising a tungsten filament light source, an incandescent light source, or a halogen light source;
determining light effect information and color information for each color block region according to the target light source of each color block region, the light effect requirement, and the color requirement, the light effect information comprising light effect type information and light effect change information, the color information comprising at least one of brightness information, color temperature information, and hue information; and
determining the regional color control parameter for each color block region according to the target light source, the light effect information, and the color information of each color block region.

14. The method for operating and controlling a combined lamp according to claim 10, wherein the light illumination color requirement comprises a light source requirement, a light effect requirement, and a color requirement;
determining the regional color control parameter for each color block region according to the light illumination color requirement comprises:
determining a target light source for each color block region according to the light source requirement, the target light source comprising a tungsten filament light source, an incandescent light source, or a halogen light source;
determining light effect information and color information for each color block region according to the target light source of each color block region, the light effect requirement, and the color requirement, the light effect information comprising light effect type information and light effect change information, the color information comprising at least one of brightness information, color temperature information, and hue information; and
determining the regional color control parameter for each color block region according to the target light source, the light effect information, and the color information of each color block region.

15. The method for operating and controlling a combined lamp according to claim 2, wherein the scene lamp requirement comprises a single lamp light distribution requirement and a single lamp color requirement when the lamp quantity information indicates that the combined lamp comprises one sub-lamp;
the generating the lamp control parameters for the combined lamp according to the lamp splicing manner and the scene lamp requirement comprises:
filtering at least one target color block that needs to be lit in the sub-lamp according to the single lamp light distribution requirement;
determining a target color block position parameter of each target color block, and determining a color control parameter for each target lamp bead in each target color block according to the target color block position parameter of each target color block and the single lamp color requirement, each target color block comprising at least one target lamp bead; and
generating the lamp control parameters for each sub-lamp according to the target color block position parameter of each target color block and the color control parameter for each target lamp bead in each target color block.

16. The method for operating and controlling a combined lamp according to claim 5, wherein the scene lamp requirement comprises a single lamp light distribution requirement and a single lamp color requirement when the lamp quantity information indicates that the combined lamp comprises one sub-lamp;
the generating the lamp control parameters for the combined lamp according to the lamp splicing manner and the scene lamp requirement comprises:
filtering at least one target color block that needs to be lit in the sub-lamp according to the single lamp light distribution requirement;
determining a target color block position parameter of each target color block, and determining a color control parameter for each target lamp bead in each target color block according to the target color block position parameter of each target color block and the single lamp color requirement, each target color block comprising at least one target lamp bead; and
generating the lamp control parameters for each sub-lamp according to the target color block position parameter of each target color block and the color control parameter for each target lamp bead in each target color block.

17. The method for operating and controlling a combined lamp according to claim 11, wherein the scene lamp requirement comprises a single lamp light distribution requirement and a single lamp color requirement when the lamp quantity information indicates that the combined lamp comprises one sub-lamp;
the generating the lamp control parameters for the combined lamp according to the lamp splicing manner and the scene lamp requirement comprises:
filtering at least one target color block that needs to be lit in the sub-lamp according to the single lamp light distribution requirement;
determining a target color block position parameter of each target color block, and determining a color control parameter for each target lamp bead in each target color block according to the target color block position parameter of each target color block and the single lamp color requirement, each target color block comprising at least one target lamp bead; and
generating the lamp control parameters for each sub-lamp according to the target color block position parameter of each target color block and the color control parameter for each target lamp bead in each target color block.

18. An apparatus for operating and controlling a combined lamp, wherein the apparatus comprises a processor configured as:
a receiving module, to receive a lamp access signal of the combined lamp, and determine lamp access information of the combined lamp according to the lamp access signal, the lamp access information comprising lamp quantity information;
a detection module, to detect a lamp splicing manner of the combined lamp according to the lamp quantity information; and
an acquisition module, to acquire a scene lamp requirement of a usage scenario corresponding to the combined lamp, and generate lamp control parameters for the combined lamp according to the lamp splicing manner and the scene lamp requirement.

19. An apparatus for operating and controlling a combined lamp, wherein the apparatus comprises:
a memory, memorized with an executable code; and
a processor, coupled with the memory,
wherein the processor invokes the executable code memorized in the memory to perform the method for operating and controlling a combined lamp according to claim 1.

20. A non-transitory computer memory medium, wherein the non-transitory computer memory medium memorizes computer instructions; when the computer instructions are invoked, the method for operating and controlling a combined lamp according to claim 1 is performed.
